(19) United States
(12) Patent Application Publication
(10) Pub. No.: US 2007/0281762 A1
(43) Pub. Date: Dec. 6, 2007

(54) SIGNAL ROUTING TO A COMMUNICATION ACCESSORY BASED ON DEVICE ACTIVATION

(75) Inventors: Mark A. Barros, Wellington, FL (US); David J. Hayes, Lake Worth, FL (US); Von A. Mock, Boynton Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/421,376

(22) Filed: May 31, 2006

(51) Int. Cl. H04M 1/00

(52) U.S. Cl. 455/575.6; 455/556.1

(57) ABSTRACT

A communication accessory (110) that includes at least a first sensor (130) that indicates whether the communication accessory is being worn by a user. The communication accessory also can include a communications adapter (210) that communicates a signal (235) which indicates to a communication device (120) whether the communication accessory is being worn. The communication accessory further can include a controller (205) that processes at least one signal generated by the first sensor to determine whether the communication accessory is being worn by the user. The controller can enter the communication accessory into a standby state in response to the first sensor indicating that the communication accessory is not being worn. The controller can take the communication accessory out of the standby state in response to the first sensor indicating that the communication accessory is being worn.

### BACKGROUND OF THE INVENTION

1. Field of the Invention

The present invention generally relates to communication input/output devices and, more particularly, to communication headsets.

2. Background of the Invention

Headsets for use with mobile communication devices, for example mobile stations, have become popular accessories. Indeed, it is now common for headsets to be worn not only while driving, but also while working, strolling through a mall, and performing activities in any other settings in which a people choose to telecommunicate. Headsets often connect to a mobile station via a wired communication link, although with the advent of Bluetooth wireless communications, wireless headsets have become fashionable in recent years.

When a headset is connected to a mobile station, all communications, including alert notifications, generally are routed through the headset. Unfortunately, people oftentimes remove their headsets without disconnecting the headsets from their mobile stations. For example, while driving, a person may tire of wearing his headset and place the headset next to him in the passenger seat. In the case of a wireless headset, if he forgets to turn off the headset, the headset may remain connected to his mobile station via a wireless communication link. Should an incoming call be received, the alert notification generally will be communicated to the headset. Since the headset's output transducer is designed for direct coupling to the ear, the sound pressure level it generates is relatively low. Thus, an alert notification generated by the headset when the headset is not being worn likely will not be heard.

### SUMMARY OF THE INVENTION

The present invention relates to a communication accessory that includes at least a first sensor that indicates whether the communication accessory is being worn by a user. The first sensor can be a mechanical contact sensor, an electrical contact sensor, a capacitive sensor, a thermal sensor, a resistive sensor, an accelerometric sensor, an infrared sensor, or an antenna loading sensor. The communication accessory also can include a communications adapter that communicates a signal which indicates to a communication device whether the communication accessory is being worn. The communication accessory further can include a controller that processes at least one signal generated by the first sensor to determine whether the communication accessory is being worn by the user.

The communication accessory also can include at least a second sensor. The first sensor and the second sensor can cooperatively indicate whether the communication accessory is being worn by the user. The controller can process at least a first signal generated by the first sensor and at least a second signal generated by the second sensor to determine whether the communication accessory is being worn by the user.

The controller can enter the communication accessory into a standby state in response to the first sensor indicating that the communication accessory is not being worn. The controller can disconnect a wireless communication link between the communication accessory and the communication device when the communication accessory enters the standby state. The controller can take the communication accessory out of the standby state in response to the first sensor indicating that the communication accessory is being worn. The controller can connect the wireless communication link between the communication accessory and the communication device when the communication accessory is taken out of the standby state.

The present invention also relates to a communication device that includes a communications adapter that receives an indicator from a communication accessory which indicates whether the communication accessory is being worn by a user. The communication device also can include a controller that selectively propagates communications signals to the communication accessory based on the received indicator. For example, the controller can propagate the communication signals to the communication accessory if the received indicator indicates that the communication accessory is being worn by the user. The communication device also can include an audio processor. The controller can propagate the communication signals to the audio processor if the received indicator indicates that the communication accessory is not being worn by the user.

The present invention also relates to a method for selectively communicating signals via a communication accessory. The method can include receiving a signal from at least a first sensor that indicates whether the communication accessory is being worn by a user. The first sensor can be a mechanical contact sensor, an electrical contact sensor, a capacitive sensor, a thermal sensor, a resistive sensor, an accelerometric sensor, an infrared sensor, or an antenna loading sensor. The method also can include communicating a signal to a communication device which indicates to the communication device whether the communication accessory is being worn. Further, the method can include receiving at least a second signal from a second sensor. The first signal and the second signal can cooperatively indicate whether the communication accessory is being worn by the user.

The communication accessory can enter into a standby state in response to the first sensor indicating that the communication accessory is not being worn. A wireless communication link between the communication accessory and the communication device can be disconnected when the communication accessory enters the standby state. The communication accessory can be taken out of the standby state in response to the first sensor indicating that the communication accessory is being worn. Further, a wireless communication link can be connected between the communication accessory and the communication device when the communication accessory is taken out of the standby state.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a communication accessory that is useful for understanding the present invention;

FIG. 3 depicts a block diagram of a communication device that is useful for understanding the present invention; and

FIG. 4 is flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

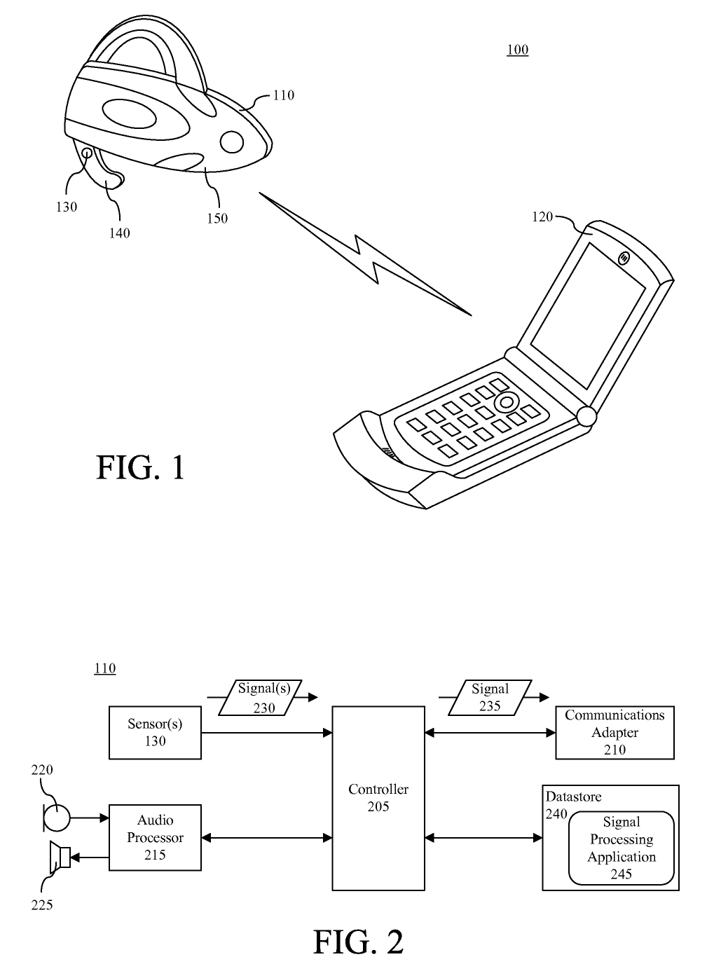

FIG. 1 depicts a communications system 100 that is useful for understanding the present invention. The communications system 100 can include a communication accessory 110, such as a headset, that automatically detects whether it is being worn, and communicates a corresponding indicator to a communication device 120 to which the communication accessory 110 is communicatively linked. Based on the indicator, the communication device 120 can selectively propagate one or more signals, for instance an alert notification or communication signals. For example, if the communication accessory 110 is being worn, the signals can be propagated to the communication accessory 110. If, however, the communication accessory 110 is not presently being worn, the signals can be propagated in another suitable manner. For example, the signals can be propagated via a suitable output transducer contained in the communication device 120.

To detect whether the communication accessory 110 is being worn, the communication accessory 110 can include a sensor 130. The sensor 130 can be any of a variety of sensors that are suitable for detecting one or more parameters that correspond to the communication accessory 110 being worn. For example, the sensor 130 can include a mechanical or electrical contact that closes or opens when in contact with another material (e.g. the user's skin or apparel worn by the user). In another example, the sensor 130 can be a capacitive sensor that senses capacitive coupling, for instance between the sensor 130 and another material. The sensor 130 also can be a thermal sensor that detects thermal energy generated by a material, a resistive sensor that senses a material based on the resistance of the material, an accelerometric sensor that senses movement of material, for instance due to blood flow and/or a heart beat, an infrared sensor that senses infrared energy and/or oxygen emanated by the user, and/or an antenna loading sensor. Still, a myriad of other types of sensors can be used to detect whether the communication accessory 110 is being worn and the invention is not limited in this regard.

In one arrangement, the communication accessory 110 can include a plurality of sensors 130, and the plurality of sensors 130 can cooperatively indicate whether the communication accessory 110 is being worn by the user. For example, the communication accessory 110 can include both a capacitive sensor and a thermal sensor. If communication accessory 110 is exposed to a temperature that is close to the temperature of the human body, the thermal sensor may generate a signal indicative of the communication accessory 110 being worn by a user. However, if the capacitive sensor does not sense the presence of another material such as skin, it can generate a signal that indicates the communication accessory 110 is not being worn. In this scenario, a determination can be made that the communication accessory 110 is not being worn.

The sensor(s) 130 can be integrated into the communication accessory 110 in any suitable manner. For instance, the sensor 130 can be integrated into an ear-loop 140 of the communication accessory 110, a base 150 of the communication accessory, or in any other components of the communication accessory 110. In another arrangement, rather than being integrated into the communication accessory 110, the sensor 130 can be attached to the person and can detect proximity of the communication accessory 110.

FIG. 2 depicts a block diagram of an example of the communication accessory 110 that is useful for understanding the present invention. The communication accessory 110 can include a controller 205. The controller 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication accessory 110 also can include a communications adapter 210 that is used by the communication accessory 110 to communicate with communication device 120. The communications adapter 210 can be configured for wired communications and/or wireless communications. For example, the communications adapter 210 can include a transceiver that communicates signals in accordance Bluetooth, or from any other communications protocol supported by the communication device 120.

The communication accessory 110 also can include an audio processor 215 connected to an input audio transducer 220 (e.g. microphone) and an output audio transducer 225 (e.g. loudspeaker). The audio processor 215 can be integrated with the controller 205, or provided as a separate component that is communicatively linked to the controller 205. The audio processor 215 can comprise a central processing unit (CPU), a digital signal processor (DSP), an application specific integrated circuit (ASIC), a programmable logic device (PLD), a plurality of discrete components that cooperate to process audio data, and/or any other suitable audio processing device. The audio processor 215 can receive input audio signals from a user wearing the communication accessory 110 via the input audio transducer 220, and propagate output audio signals to the user via the output audio transducer 225.

In operation, the sensor(s) 130 can detect one or more parameters and forward corresponding signals 230 to the controller 205. The controller 205 can process the signals 230 to determine whether the communication accessory 110 is being worn by the user. For example, if the communication accessory 110 comprises a single sensor 130, the controller 205 can process one or more signals 230 generated by that sensor 130 to determine whether the communication accessory 110 is being worn and propagate a corresponding signal 235 to the communications adapter 210, which can forward the signal 235 to the communication device. If, however, the communication accessory 110 comprises a plurality of sensors 130, the controller 205 can receive one or more signals 230 from each of the sensors 130 and process such signals to determine whether the communication accessory 110 is being worn.

In one arrangement, the communication accessory 110 can include a datastore 240 on which a signal processing application 245 is stored for processing the signals 230. The signal processing application 245 can be executed by the controller 205 and can include, for example, one or more algorithms that account for various sensor readings in order to arrive at an accurate determination as to whether the communication accessory 110 is being worn. The datastore 240 can include a magnetic storage medium, an electronic storage medium, an optical storage medium, a magneto-optical storage medium, or any other storage medium suitable for storing digital information. In one aspect of the invention, the datastore 240 can be integrated into the controller 205.

In one arrangement, if the signal(s) 230 indicate that the communication accessory 110 is not being worn, the controller 205 can enter the communication accessory 110 into a standby state, thereby reducing energy usage and extending battery life. In the standby state the communication accessory 110 can remain connected to the communication device. Alternatively, if the communication accessory 110 wirelessly communicates with the communication device, in the standby state the communication accessory 110 can disconnect its wireless communication link with the communication device.

When the signal 230 again indicates that the communication accessory 110 is being worn, the controller 205 can take the communication accessory 110 out of the standby state and into a state in which the communication accessory 110 is ready to communicate with the communication device and ready to send and receive audio signals via the audio transducers 220, 225. If the communication accessory 110 was not connected to the communication device during the standby state, the controller 205 can communicate with the communications adapter 210 to connect, or reconnect, a wireless communications link with the communication device.

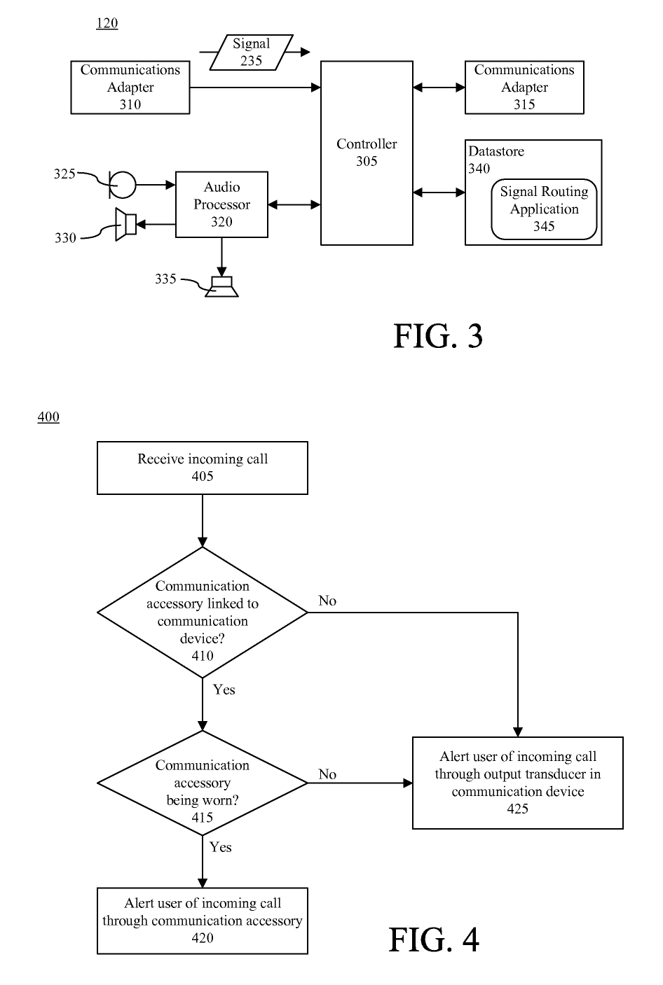

FIG. 3 depicts a block diagram of an example of the communication device 120 that is useful for understanding the present invention. The communication device 120 can include a controller 305. The controller 305 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication device 120 also can include a communications adapter 310 with which the communication device 120 communicates with communication accessory. The communications adapter 310 can be configured for wired communications and/or wireless communications. For example, the communications adapter 310 can include a transceiver that communicates signals in accordance Bluetooth, or from any other communications protocol supported by the communication adapter.

A second communications adapter 315 also can be provided support communications between the communication device 120 and a communication network. The communications adapter 315 can include, for example, a transceiver that communicates data via IEEE 802 wireless communications, WPA, WPA2, GSM, TDMA, CDMA, WCDMA, direct wireless communication, TCP/IP, or any other suitable form of communications. Moreover, the communications adapter 315 also can include a network adapter, a serial communications port, a parallel communications port, or any other suitable port through which the communication device 120 can receive signals communicated over a wired link. In one arrangement, the communications adapter 315 can be integrated with the communications adapter 310.

The communication device 120 also can include an audio processor 320 connected to an input audio transducer 325 (e.g. microphone) and an output audio transducer 330 (e.g. loudspeaker). The audio processor 320 can be integrated with the controller 305, or provided as a separate component that is communicatively linked to the controller 305. The audio processor 320 can comprise a central processing unit (CPU), a digital signal processor (DSP), an application specific integrated circuit (ASIC), a programmable logic device (PLD), a plurality of discrete components that cooperate to process audio data, and/or any other suitable audio processing device. The audio processor 320 can receive input audio signals from a user via the input audio transducer 325, and propagate output audio signals to the user via the output audio transducer 330.

The audio processor also can be connected to a second output audio transducer 335 that generates audio signals at a higher volume than the output audio transducer 330. For example, when appropriate, the audio processor 320 can direct alert notifications to the output audio transducer 335. The audio processor 320 also can direct audio communication signals to the output audio transducer 335 when the communication device 120 is being used in hands-free mode without use of the communication accessory.

The communication device 120 also can include a datastore 340. The datastore 340 can include a magnetic storage medium, an electronic storage medium, an optical storage medium, a magneto-optical storage medium, or any other storage medium suitable for storing digital information. In one arrangement, the datastore 340 can be integrated into the controller 305.

A signal routing application 345 can be contained on the datastore 340. The signal routing application 345 can be executed by the controller 205 to selectively propagate one or more signals, for instance an alert notification or communication signals, to the communication accessory and implement other processes described herein.

In operation, the communications adapter 310 can receive the signal 235, if present, from the communication accessory and forward the signal 235 to the controller 305. If the signal 235 indicates that the communication accessory is not being worn by the user, or the signal 235 is not present, the controller can forward signals, such as communication signals and alert notifications to the audio processor 320. The audio processor 320 can forward communication signals to the output audio transducer 330 and forward alert notifications to the output audio transducer 335. In addition, the audio processor 320 can receive audio signals from the input audio transducer 325 and forward such signals to the controller 305 for further communications processing. In another arrangement, the audio processor 320 can exchange the communication signals with another device with which the communication device 120 is communicatively linked, for example an audio system within a vehicle.

If the signal 235 indicates that the communication accessory is being worn by the user, rather than sending communication signals to the audio processor 320, such signals can be forwarded to the communications adapter 310 and communicated to the communication accessory. For example, responsive to receiving an incoming call, the controller 305 can forward an alert notification to the communication adapter 310, which can communicate the alert notification to the communication accessory. The communication accessory can present the alert notification to the user. Communication signals received during the call session also can be communicated to the communication accessory in a similar manner for presentation to the user. The controller 305 can redirect the communication signals should the signal 235 change or cease being detected. The signal 235 may cease being detected if the communication accessory enters a standby state in which it disconnects a communication link with the communication device.

FIG. 4 is flowchart that is useful for understanding the present invention. At step 405, an incoming call can be received. Referring to decision boxes 410 and 415, if the communication accessory is communicatively linked to the communication device and the communication accessory is being worn, the process can continue to step 420 and an alert notification can be presented to the user through the communication accessory. If, however, the communication accessory is not connected to the communication device, or the communication accessory is not being worn, at step 425 the alert notification can be presented to the user through an output audio transducer in the communication device, or another device to which the communication device is communicatively linked.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A communication accessory, comprising:
at least a first sensor that indicates whether the communication accessory is being worn by a user; and
a communications adapter that communicates a signal which indicates to a communication device whether the communication accessory is being worn.

2. The communication accessory of claim 1, further comprising a controller that processes at least one signal generated by the first sensor to determine whether the communication accessory is being worn by the user.

3. The communication accessory of claim 1, further comprising at least a second sensor, wherein the first sensor and the second sensor cooperatively indicate whether the communication accessory is being worn by the user.

4. The communication accessory of claim 3, further comprising a controller that processes at least a first signal generated by the first sensor and at least a second signal generated by the second sensor to determine whether the communication accessory is being worn by the user.

5. The communication accessory of claim 1, further comprising a controller that enters the communication accessory into a standby state in response to the first sensor indicating that the communication accessory is not being worn.

6. The communication accessory of claim 5, wherein the controller disconnects a wireless communication link between the communication accessory and the communication device when the communication accessory enters the standby state.

7. The communication accessory of claim 5, wherein the controller takes the communication accessory out of the standby state in response to the first sensor indicating that the communication accessory is being worn.

8. The communication accessory of claim 7, wherein the controller connects a wireless communication link between the communication accessory and the communication device when the communication accessory is taken out of the standby state.

9. The communication accessory of claim 1, wherein the first sensor is a sensor selected from the group consisting of a mechanical contact sensor, an electrical contact sensor, a capacitive sensor, a thermal sensor, a resistive sensor, an accelerometric sensor, an infrared sensor, and an antenna loading sensor.

10. A communication device, comprising:
a communications adapter that receives an indicator from a communication accessory which indicates whether the communication accessory is being worn by a user; and
a controller that selectively propagates communications signals to the communication accessory based on the received indicator.

11. The communication device of claim 10, wherein the controller propagates the communication signals to the communication accessory if the received indicator indicates that the communication accessory is being worn by the user.

12. The communication device of claim 10, wherein the communication device comprises an audio processor, and the controller propagates the communication signals to the audio processor if the received indicator indicates that the communication accessory is not being worn by the user.

13. The communication device of claim 10, wherein the communication device comprises an audio processor, the controller propagates the communication signals to the audio processor if the received indicator indicates that the communication accessory is not being worn by the user, and the controller propagates the communication signals to the communication accessory if the received indicator indicates that the communication accessory is being worn by the user.

14. A method for selectively communicating signals via a communication accessory, comprising:
receiving a signal from at least a first sensor that indicates whether the communication accessory is being worn by a user; and
communicating a signal to a communication device which indicates to the communication device whether the communication accessory is being worn.

15. The method of claim 14, further comprising receiving at least a second signal from a second sensor, the first signal and the second signal cooperatively indicating whether the communication accessory is being worn by the user.

16. The method of claim 14, further comprising entering the communication accessory into a standby state in response to the first sensor indicating that the communication accessory is not being worn.

17. The method of claim 16, further comprising disconnecting a wireless communication link between the communication accessory and the communication device when the communication accessory enters the standby state.

18. The method of claim 16, further comprising taking the communication accessory out of the standby state in response to the first sensor indicating that the communication accessory is being worn.

19. The method of claim 18, further comprising connecting a wireless communication link between the communication accessory and the communication device when the communication accessory is taken out of the standby state.

20. The method of claim 14, further comprising selecting the first sensor from the group consisting of a mechanical contact sensor, an electrical contact sensor, a capacitive sensor, a thermal sensor, a resistive sensor, an accelerometric sensor, an infrared sensor, and an antenna loading sensor.
